(19) United States
(12) Patent Application Publication
(10) Pub. No.: US 2019/0266530 A1
(43) Pub. Date: Aug. 29, 2019

(54) Management System and Method of Use for Improving Safety Management of Fuels and Petrochemical Facilities

(71) Applicant: Michael Marshall, LLC, Findlay, OH (US)

(72) Inventor: Michael Thomas Marshall, Findlay, OH (US)

(21) Appl. No.: 16/412,232

(22) Filed: May 14, 2019

Related U.S. Application Data
(63) Continuation-in-part of application No. 15/194,559, filed on Jun. 27, 2016.
(60) Provisional application No. 62/671,252, filed on May 14, 2018.
(60) Provisional application No. 62/184,336, filed on Jun. 25, 2015.
(60) Provisional application No. 62/184,124, filed on Jun. 24, 2015.

(51) Int. Cl. G06Q 10/06; G06Q 10/00; G06Q 50/06

(52) U.S. Cl. CPC G06Q 10/0635; G06Q 50/06; G06Q 10/0639; G06Q 10/20

(57) ABSTRACT

A management system for calculating a management solution from an EAM data. The management system comprises one or more computers including at least a server, and a first computer, and a network. The server comprises an EAM platform comprising a server application. The EAM platform is configured to collect the EAM data selected among a financial data, a maintenance data, an engineering data, an operational data, and an incident data. The one or more computers further comprise a management software configured to communicate with the EAM platform and analyze the EAM data to generate the management solution.

### CROSS-REFERENCE TO RELATED APPLICATIONS

This application claims benefit to U.S. Patent Application No.(s) 62/671,252 filed on May 14, 2018, Ser. No. 15/194,559 filed on Jun. 27, 2016, 62/184,336 filed on Jun. 25, 2015 and 62/184,124 filed on Jun. 24, 2015.

### STATEMENT REGARDING FEDERALLY SPONSORED RESEARCH OR DEVELOPMENT (IF APPLICABLE)

Not applicable.

### REFERENCE TO SEQUENCE LISTING, A TABLE, OR A COMPUTER PROGRAM LISTING COMPACT DISC APPENDIX (IF APPLICABLE)

Not applicable.

### BACKGROUND OF THE INVENTION

No prior art is known to the Applicant.

Problem Solved: The creators of oil and gas industry software are often information technology (IT)

specialists who provide an IT answer for a problem which requires a user specific solution.

Our industry can be even more critical and innovative in responding to LOPC incidents by improving data and metrics relative to equipment inspection, maintenance, design and overall systems management.

This invention is an improvement on what currently exists. Of specific need is a loss of primary containment (LOPC) focused, metrics-driven management system and asset optimization database tool which, when properly deployed together, drive improvement in operations, reliability, profitability, and most importantly process safety.

At the center of the management system methodology is the unique design and implementation of metrics and KPIs created from data lifted and aggregated from an enterprise asset management platform (EAM). Of course, knowing the 20% of data that 80% of operators, engineers, managers and executives want to see is essential to proper metrics development and analysis, and the ensuing derivation of key performance indicators (KPIs). This management system process focuses on the four key business drivers of risk, regulatory, operations, and profits, and involves several distinct business methods involving people, processes and tools. As for tools, the key to this approach is a time-tested process optimization methodology utilizing root cause failure analysis (RCFA) which reveals process safety opportunities and quantifies the economic impacts ($'s lost profit opportunity LPO) of equipment anomalies, LOPC incidents and upset/malfunction operating conditions. Such a RCFA approach is key to analyzing and trending cost minimization, driving asset/process optimization and maximizing process safety performance in the refining industry.

The claimed invention differs from what currently exists. The creators of oil and gas industry software are often information technology (IT) specialists who provide an IT answer for a problem which requires a user specific solution. The invention claimed here solves this problem. What is preferable is the oil and gas industry “hands-on” experience of a subject matter expert (SME) who “knows what good looks like” when it comes to the functionality and usability needs of software tools. With the ultimate objective of improving refining-w ide mechanical availability and lowering maintenance expense

(as percent of RAV), this management system methodology and associated refining specific incident and loss database and optimization methodology (utilizing RCFA) quantifies the economic impact ($'s lost profit opportunity LPO) of equipment anomalies, LOPC incidents and upset/malfunction operating conditions.

### BRIEF SUMMARY OF THE INVENTION

A management system for calculating a management solution from an EAM data. Said management system comprises one or more computers including at least a server, and a first computer, and a network. Said server comprises an EAM platform comprising a server application. Said EAM platform is configured to collect said EAM data selected among a financial data, a maintenance data, an engineering data, an operational data, and an incident data. Said one or more computers further comprise a management software configured to communicate with said EAM platform and analyze said EAM data to generate said management solution.

A method of use of said management system for calculating said management solution from said EAM data. collecting said EAM data with said EAM platform on said server. Analyzing said EAM data with said management software configured to communicate with said EAM platform (614). generating said management solution (620).

### BRIEF DESCRIPTION OF THE SEVERAL VIEWS OF THE DRAWING

FIG. 1 illustrates network diagram 102 of a management system 100.

FIGS. 2A, 2B, 2C, 2D and 2E illustrate a mobile phone 200a, a personal computer 200b, a tablet 200c, a smart watch 200d and a smart phone 200e, respectively.

FIGS. 3A, 3B and 3C illustrate an address space 302, an address space 302a and an address space 302e, respectively.

FIGS. 4A and 4B illustrate a flow chart between one or more computers 106 and a server 108.

FIGS. 5A and 5B illustrate interactions between a device application 502, a server application 506 and a data storage 110.

FIG. 6 illustrates a method of use 602 for said management system 100 as a flow chart.

FIG. 7 illustrates a flow chart of a management software 618 creating a management solution 620.

FIG. 8 illustrates an equipment monitoring flow chart 802 of an evaluating tools method 706 of said management software 618.

FIG. 9 illustrates a lost profit opportunity score card 902.

FIG. 10 illustrates a RILR 1002.

FIG. 11 illustrates an incident and loss report key 1102 which can correspond with said RILR 1002.

FIG. 12 illustrates a risk screening analysis worksheet 1202 which, likewise, can correspond with said RILR 1002.

FIG. 13 illustrates a plurality of reliability data charts 1302 in said management software 618.

FIG. 14 illustrates a second portion of said plurality of reliability data charts 1302.

FIG. 15 illustrates a third portion of said plurality of reliability data charts 1302.

FIG. 16 illustrates where said management software 618 could fit in between legacy systems 1602 and advanced corrective action 1604.

FIG. 17 illustrates an asset integrity analytical framework flowchart 1702.

FIG. 18 illustrates a predictive process safety analytics 1802.

FIG. 19 illustrates an industry comparative benchmarking 1902.

FIG. 20 illustrates a chart 2002.

FIG. 21 illustrates a chart 2102.

FIG. 22 illustrates a chart 2202.

### DETAILED DESCRIPTION OF THE INVENTION

The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

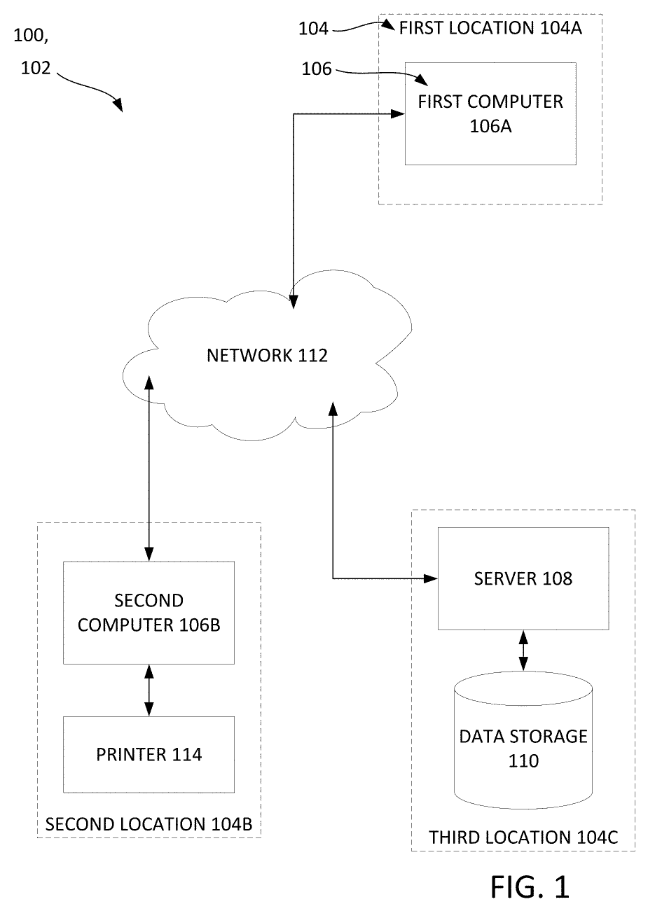

FIG. 1 illustrates network diagram 102 of a management system 100.

In one embodiment, said network diagram 102 can comprise one or more computers 106, one or more locations 104, and a network 112. In one embodiment, said one or more locations 104 can comprise a first location 104a, a second location 104b and a third location 104c. Said one or more computers 106 can comprise a first computer 106a, a second computer 106b, a wearable computer 106c, a wearable computer 106d and a third computer 106e. In one embodiment, a server 108 can communicate with said one or more computers 106 over said network 112. Said one or more computers 106 can be attached to a printer 114 or other accessories, as is known in the art.

In one embodiment, said server 108 can attach to a data storage 110.

In one embodiment, said printer 114 can be hardwired to said first computer 106a (not illustrated here), or said printer 114 can connect to one of said one or more computers 106 (such as said second computer 106b, as illustrated) via said network 112.

Said network 112 can be a local area network (LAN), a wide area network (WAN), a piconet, or a combination of LANs, WANs, or piconets. One illustrative LAN is a network within a single business. One illustrative WAN is the Internet.

In one embodiment, said server 108 represents at least one, but can be many servers, each connected to said network 112. Said server 108 can connect to said data storage 110. Said data storage 110 can connect directly to said server 108, as shown in FIG. 1, or may exist remotely on said network 112. In one embodiment, said data storage 110 can comprise any suitable long-term or persistent storage device and, further, may be separate devices or the same device and may be collocated or distributed (interconnected via any suitable communications network).

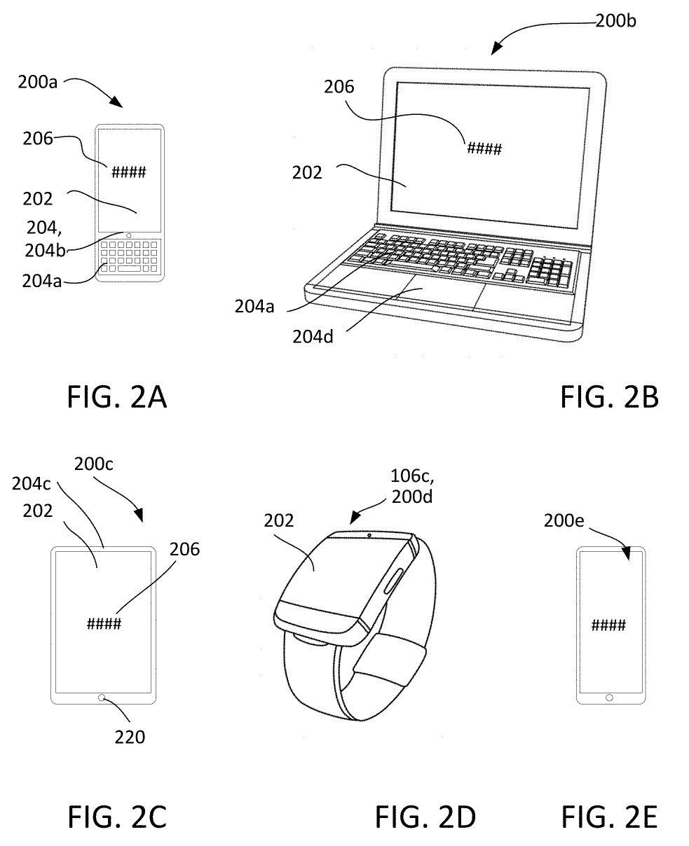

FIGS. 2A, 2B, 2C, 2D and 2E illustrate a mobile phone 200a, a personal computer 200b, a tablet 200c, a smart watch 200d and a smart phone 200e, respectively.

In one embodiment, said one or more computers 106 can comprise said mobile phone 200a, said personal computer 200b, said tablet 200c, said smart watch 200d or said smart phone 200e. In one embodiment, each among said one or more computers 106 can comprise one or more input devices 204, a keyboard 204a, a trackball 204b, one or more cameras 204c, a track pad 204d, a data 206 and/or a home button 220, as is known in the art.

In the last several years, the useful definition of a computer has become more broadly understood to include mobile phones, tablet computers, laptops, desktops, and similar. For example, Microsoft®, have attempted to merge devices such as a tablet computer and a laptop computer with the release of “Windows® 8”. In one embodiment, said one or more computers each can include, but is not limited to, a laptop (such as said personal computer 200b), desktop, workstation, server, mainframe, terminal, a tablet (such as said tablet 200c), a phone (such as said mobile phone 200a), and/or similar. Despite different form-factors, said one or more computers can have similar basic hardware, such as a screen 202 and said one or more input devices 204 (such as said keyboard 204a, said trackball 204b, said one or more cameras 204c, a wireless—such as RFID—reader, said track pad 204d, and/or said home button 220). In one embodiment, said screen 202 can comprise a touch screen. In one embodiment, said track pad 204d can function similarly to a computer mouse as is known in the art. In one embodiment, said tablet 200c and/or said personal computer 200b can comprise a Microsoft® Windows® branded device, an Apple® branded device, or similar. In one embodiment, said tablet 200c can be an X86 type processor or an ARM type processor, as is known in the art.

Said network diagram 100 can comprise said data 206. In one embodiment, said data 206 can comprise data related to financial transactions.

In one embodiment, said one or more computers can be used to input and view said data 206. In one embodiment, said data 206 can be input into said one or more computers by taking pictures with one of said one or more camera 204c, by typing in information with said keyboard 204a, or by using gestures on said screen 202 (where said screen 202 is a touch screen). Many other data entry means for devices like said one or more computers are well known and herein also possible with said data 206. In one embodiment, said first computer 102a can comprise an iPhone®, a BlackBerry®, a smartphone, or similar. In one embodiment, one or more computers can comprise a laptop computer, a desktop computer, or similar.

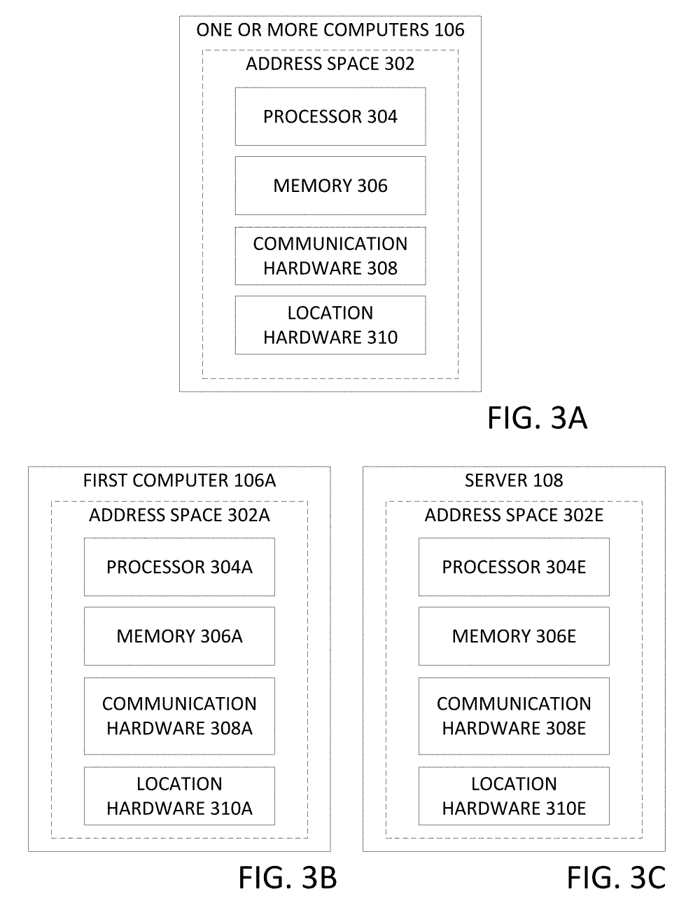

FIGS. 3A, 3B and 3C illustrate an address space 302, an address space 302a and an address space 302e, respectively.

In one embodiment, said one or more computers 106 can comprise said address space 302, and more specifically, said first computer 106a can comprise said address space 302a, said second computer 106b can comprise an address space 302b, said wearable computer 106c can comprise an address space 302c, said wearable computer 106d can comprise an address space 302d; and said server 108 can comprise said address space 302e. In turn, each among said address space 302 can comprise a processor 304, a memory 306, a communication hardware 308 and a location hardware 310. Thus, said address space 302a a processor 304a, a memory 306a, a communication hardware 308a and a location hardware 310a; said address space 302b can comprise a processor 304b, a memory 306b, a communication hardware 308b and a location hardware 310b; said address space 302c can comprise a processor 304c, a memory 306c, a communication hardware 308c and a location hardware 310c; said address space 302d can comprise a processor 304d, a memory 306d, a communication hardware 308d and a location hardware 310d; and said address space 302e can comprise a processor 304e, a memory 306e, a communication hardware 308e and a location hardware 310e.

Each among said one or more computers 106 and said server 108 can comprise an embodiment of said address space 302. In one embodiment, said processor 304 can comprise a plurality of processors, said memory 306 can comprise a plurality of memory modules, and said communication hardware 308 can comprise a plurality of communication hardware components. In one embodiment, said data 206 can be sent to said processor 304; wherein, said processor 304 can perform processes on said data 206 according to an application stored in said memory 306, as discussed further below. Said processes can include storing said data 206 into said memory 306, verifying said data 206 conforms to a one or more preset standards, or ensuring a required set among said required said data 206 has been gathered for said data management system and method. In one embodiment, said data 206 can include data which said one or more computers 106 can populate automatically, such as a date and a time, as well as data entered manually. Once a portion of gathering data has been performed said data 206 can be sent to said communication hardware 308 for communication over said network 112. Said communication hardware 308 can include a network transport processor for packetizing data, communication ports for wired communication, or an antenna for wireless communication. In one embodiment, said data 206 can be collected in one or more computers and delivered to said server 108 through said network 112.

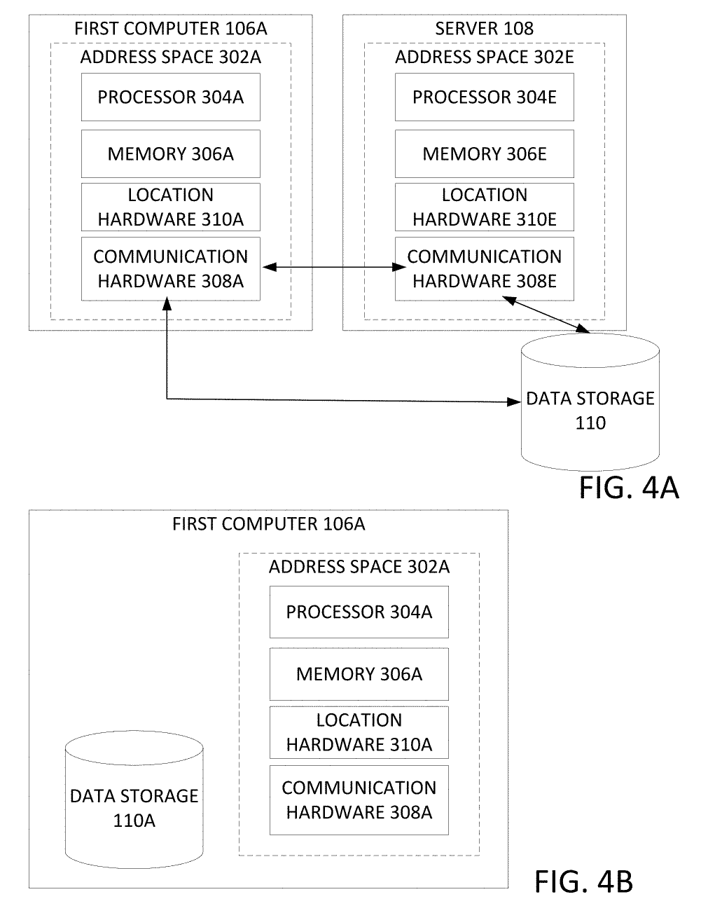

FIGS. 4A and 4B illustrate a flow chart between said one or more computers 106 and said server 108.

In the first embodiment, said communication hardware 308a and said communication hardware 308e can send and receive said data 206 to and from one another and or can communicate with said data storage 110 across said network 112. Likewise, in the second embodiment, said data storage 110 can be embedded inside of said one or more computers 106, which may speed up data communications over said network 112.

As illustrated in FIG. 4A, in one embodiment, said server 108 can comprise a third-party data storage and hosting provider or privately managed as well.

As illustrated in FIG. 4B, a data storage 110a can be located on said first computer 106a. Thus, said first computer 106a can operate without a data connection out to said server 108.

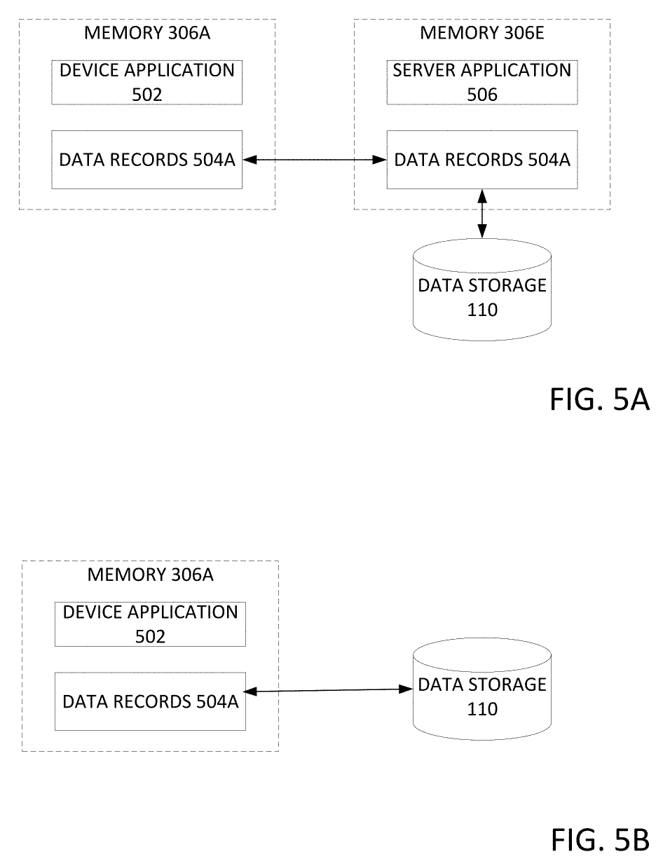

FIGS. 5A and 5B illustrate interactions between a device application 502, a server application 506 and said data storage 110.

For nomenclature, each among data records can comprise a set of data records in use on said one or more computers 106; thus said first computer 106a can comprise a data records 504a, said second computer 106b can comprise a data records 504b, said wearable computer 106c can comprise a data records 504c, and said wearable computer 106d can comprise a data records 504d.

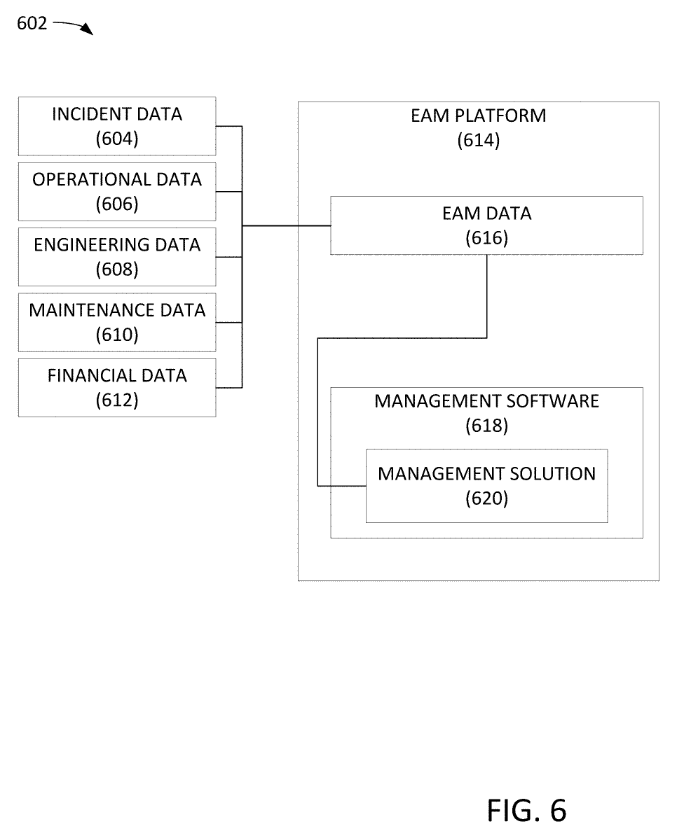

FIG. 6 illustrates a method of use 602 for said management system 100 as a flow chart.

In one embodiment, said method of use 602 can comprise receiving an incident data 604, an operational data 606, an engineering data 608, a maintenance data 610 and a financial data 612 into an EAM platform 614 (or “enterprise asset management” platform). In one embodiment, said EAM platform 614 can comprise SAP, Maximo or another platform, as is known in the art. Said method of use 602 can further comprise analyzing an EAM data 616 with a management software 618; and developing a management solution 620 based with said management software 618.

In one embodiment, said management solution 620 developed by said management software 618 can comprise databases, KPIs, data maps, score cards, dashboards, reports, portals, alerts, analyses, or similar, as discussed herein.

In one embodiment, said management software 618 can comprise an user-configurable module within said EAM platform 614. Said management software 618 can be referred to as a “PSM” Plus software, and can comprise an incident and loss prevention database application as well as an enterprise risk management methodology.

In one embodiment, said management software 618 can quantify the economic impact (lost profit opportunity plus direct costs) of equipment anomalies, loss of primary containment (LOPC) incidents and upset/malfunction operating conditions. It also includes numerous metrics and KPIs specific to LOPC, loss prevention, EHS risk screening and API 754 PSE performance (including a LOPC [or Loss] Intensity Index [LII]).

As a predictive process safety analytics tool, said management software 618 can focus on asset integrity management, and can be designed to maximize equipment uptime (mechanical availability), optimize operational performance (via operations, maintenance/inspection, and engineering), increase productivity and decrease costs (providing a basis for % RAV and ROI), drive process safety improvements (minimizing LOPC as well as near misses relative to risk-based inspection API 580/581, OSHA PSM, API 1173, etc.), and facilitate enterprise risk management/benchmarking.

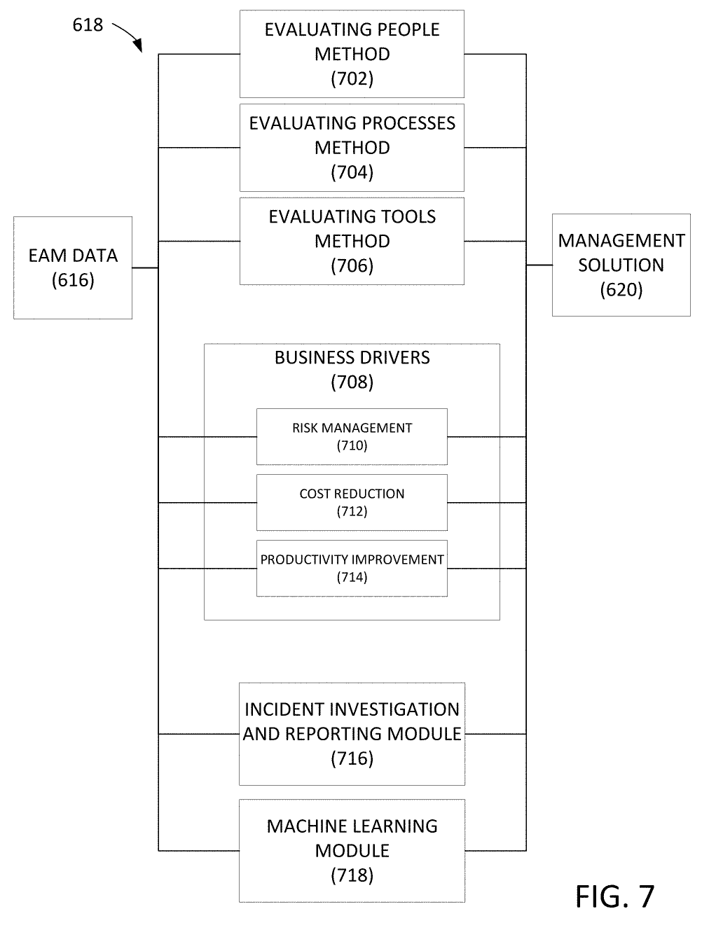

FIG. 7 illustrates a flow chart of said management software 618 creating said management solution 620.

In one embodiment, said management software 618 can include business methods such as an evaluating people method 702, an evaluating processes method 704 and an evaluating tools method 706 (which can comprise technology evaluation). Further, said management software 618 can focus on the three high value Operational Excellence (OE) business drivers 708 of risk management 710, cost reduction 712, and productivity improvement 714.

In one embodiment, said management software 618 can be deployed as a web-based analytic framework. In one embodiment, said management software 618 can comprise an incident investigation and reporting module 716 which can utilize a field-tested system for the characterization, classification and categorization of asset integrity and process safety incidents risk-ranked and prioritized by API 754 PSE potential as well as economic impact (again, lost production plus direct losses).

In one embodiment, said management software 618 can comprise a machine learning module 718 comprising techniques to scour historical incidents to find meaningful patterns in said EAM data 616 (a.k.a. “PSM Plus data”) and to prioritize and guide investigative teams to high value problem-solving exercises.

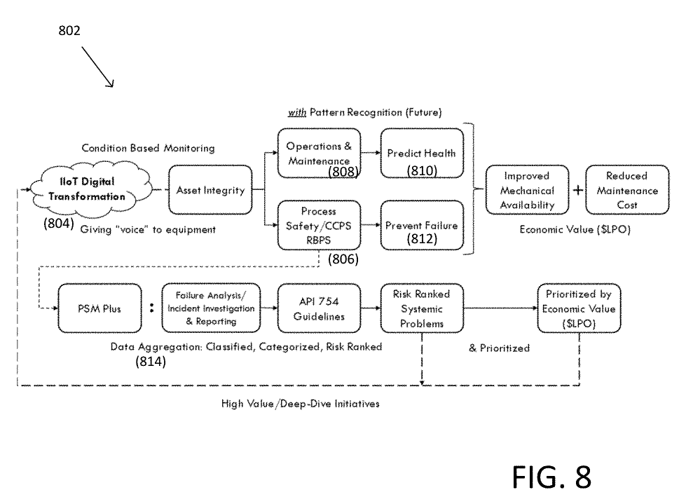

FIG. 8 illustrates an equipment monitoring flow chart 802 of said evaluating tools method 706 of said management software 618.

In one embodiment, said evaluating tools method 706 can comprise receiving an equipment status data 804 (“interne of things” data) from operational equipment, analyzing said equipment status data 804 to determine a safety status 806, a maintenance status 808, a predictive health 810, and a predictive failure 812. Further, said evaluating tools method 706 can comprise a data aggregation and analysis method 814 which can comprise failure analysis, API 754 guidelines analysis, risk ranking and LPO, as illustrated.

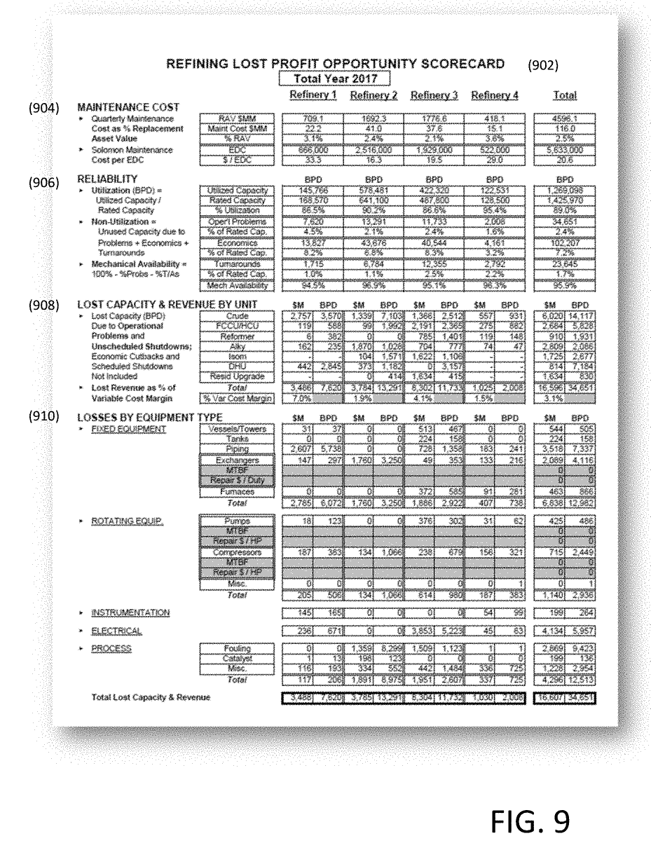

FIG. 9 illustrates a lost profit opportunity score card 902.

Two high-level indicators used to evaluate manufacturing cost effectiveness are mechanical availability and maintenance costs as a percent of replacement asset value (RAV). It is widely accepted by Oil & Gas industry experts that world class manufacturing performance means operating at or above 97% mechanical availability as well as spending less than 2% on maintenance as a percent of replacement asset value (RAV).

In order to achieve such “best in class” targets, tools must be used to analyze and trend performance relative to those measures. Deep-dive methods must surface indicators which drive toward systemic root causes of inadequate performance and reveal both asset integrity and process safety incidents as a function of economic impact. As such, lost profit opportunity ($LPO) becomes a measure of loss of primary containment (LOPC) incidents and near misses characterized by equipment anomalies and upset/malfunction operating conditions.

If 97% mechanical availability is now considered world-class asset integrity, could sustained 98% or 99% availability be achievable by coupling the incident investigation and reporting analytic framework of PSM Plus, with condition monitoring Industrial IoT (IIoT) technologies like predictive analytics, Advanced Pattern Recognition (APR) and machine learning? Considering that every 1% gain in mechanical availability is now worth about $8.4 million of additional margin capture per year in a typical 200,000 bpd refinery, the low-cost, high impact potential of a systemic RCFA approach like PSM Plus is a logical next step for IIoT predictive analytics.

Accordingly, said management software 618 can generate and maintain said lost profit opportunity score card 902 which can calculate a maintenance cost 904, a reliability score 906, a lost capacity by revenue unit score 908, and a loss by equipment type score 910. In one embodiment, said lost profit opportunity score card 902 can be broken down by refinery or period, of time, as illustrated.

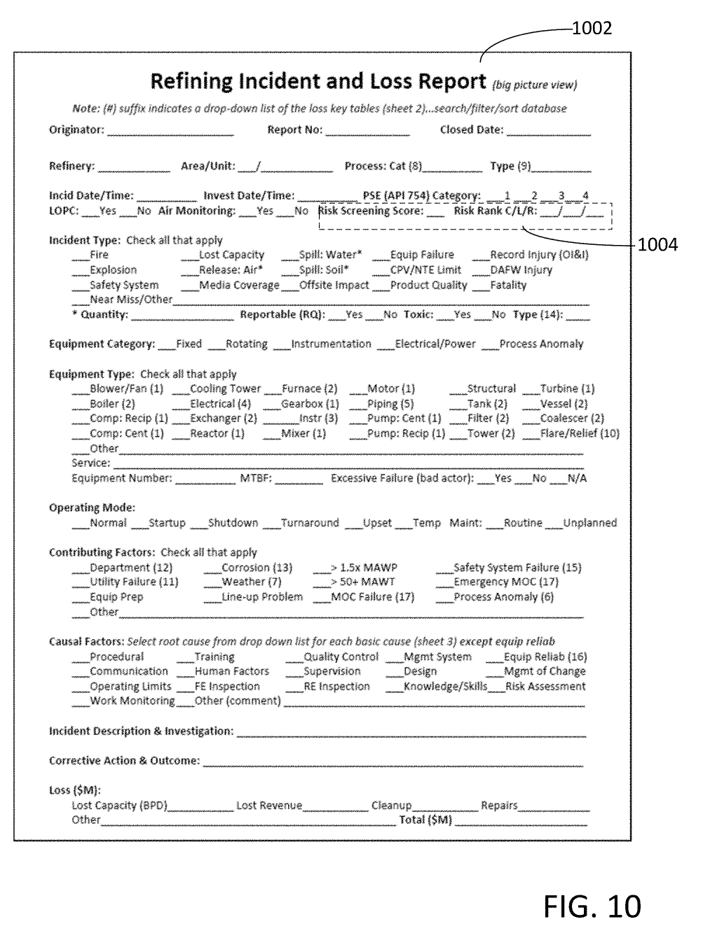

FIG. 10 illustrates a RILR 1002.

In one embodiment, said RILR 1002 can comprise a refining incident and loss report, as illustrated. Said RILR 1002 can comprise a paper form, an electronic form, or similar.

Of the fourteen Process Safety Management (PSM) elements, incident investigation can provide the best window on asset integrity, plant reliability and process safety risk management, and which gets the most attention from the regulatory community. Incident analyses almost always show that loss of primary containment (LOPC) is preventable, with mechanical failure far exceeding the next highest categories of operator error, other/unknown and upset/malfunction which all together constitute the leading process safety risk opportunities for improved performance in the process industry today.

The characterization, categorization, risk-ranking and prioritization of incident data (especially the near-miss “free lessons”) is especially critical for identifying systemic problems and converting into leading indicators of more serious process safety event (API 754 PSE) potential. In order to drive continuous improvement with mechanical availability and process safety, ALL incident data must be analyzed for systemic effect in order to maximize the knowledge base necessary to reduce the risk of LOPC occurrence as well as minimize lost profit opportunity (LPO).

In one embodiment, said RILR 1002 can comprise one or more risk assessment questions 1004.

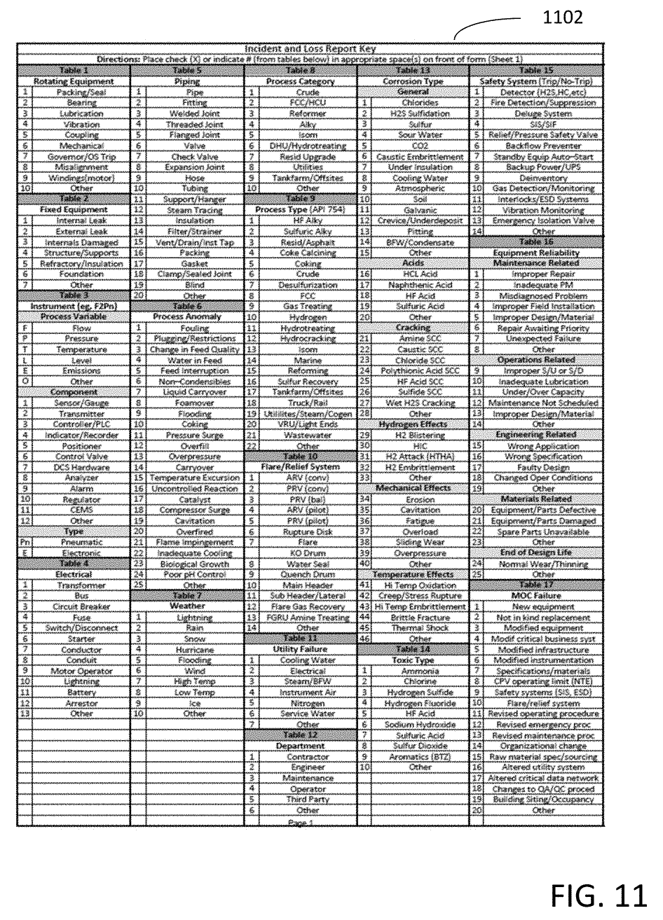

FIG. 11 illustrates an incident and loss report key 1102 which can correspond with said RILR 1002.

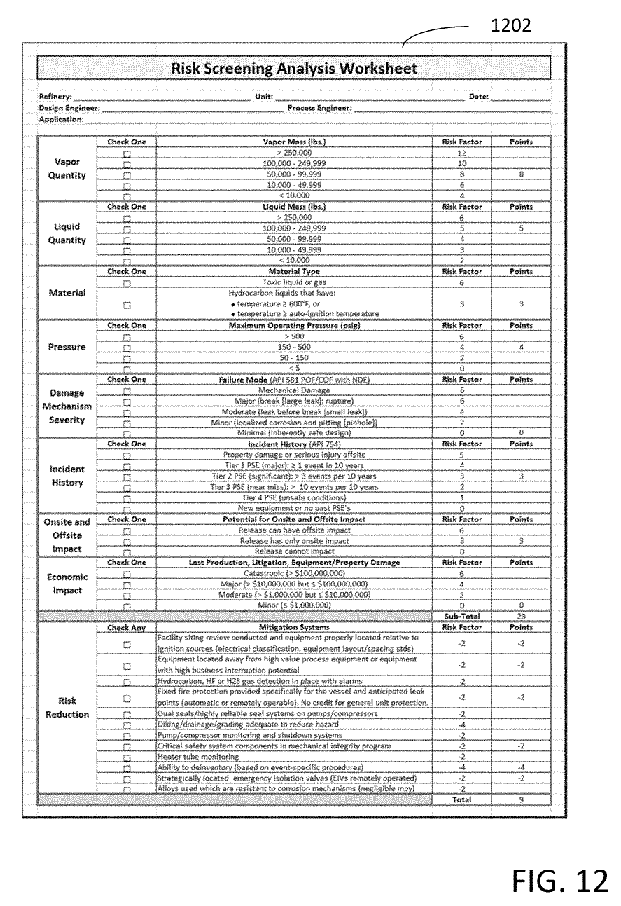

FIG. 12 illustrates a risk screening analysis worksheet 1202 which, likewise, can correspond with said RILR 1002.

In one embodiment, said one or more risk assessment questions 1004 can further comprise said risk screening analysis worksheet 1202. Said risk screening analysis worksheet 1202 can comprise a utilizes a calibrated/weighted asset risk ranking tool and methodology which facilitates the proper allocation of tools and resources for identifying performance optimization opportunities and driving operational excellence (OE) initiatives. Emphasizing the value of this incident management systems approach drives the proper prioritization of opportunities and virtually guarantees the successful outcome of the exercise.

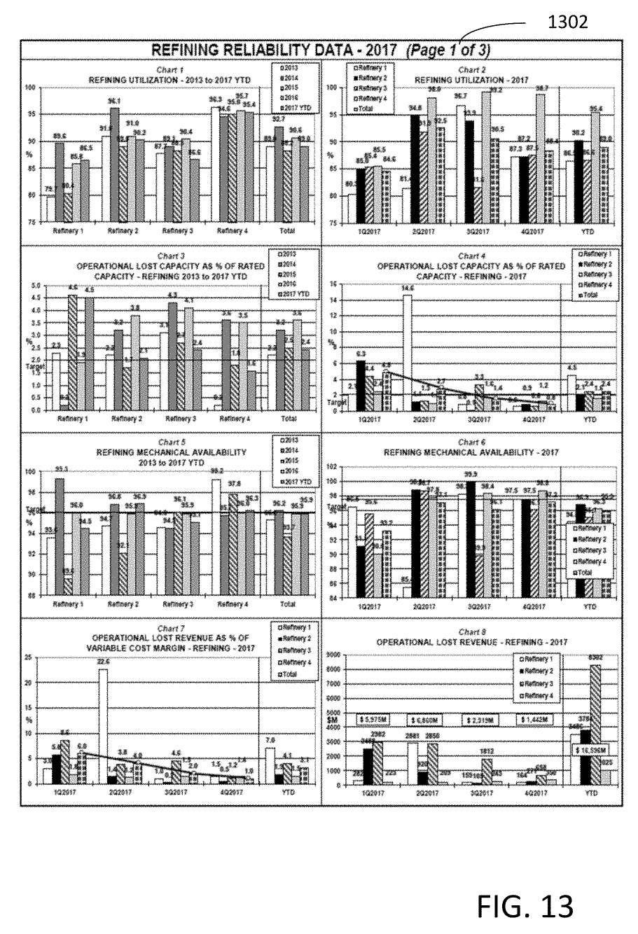

FIG. 13 illustrates a plurality of reliability data charts 1302 in said management software 618.

In one embodiment, said plurality of reliability data charts 1302 can comprise benchmarking (both internally and externally) of equipment reliability. Said management software 618 can process safety management program maturity as well as the establishment of an industry PSM accreditation model. Such a model might entail conformance with elements of the AIChE CCPS book “Risk Based Process Safety” and also include a more robust capture, analysis, and benchmarking of API 754 PSEs relative to incident precursors, data patterns, IOW excursions as well as other leading indicators.

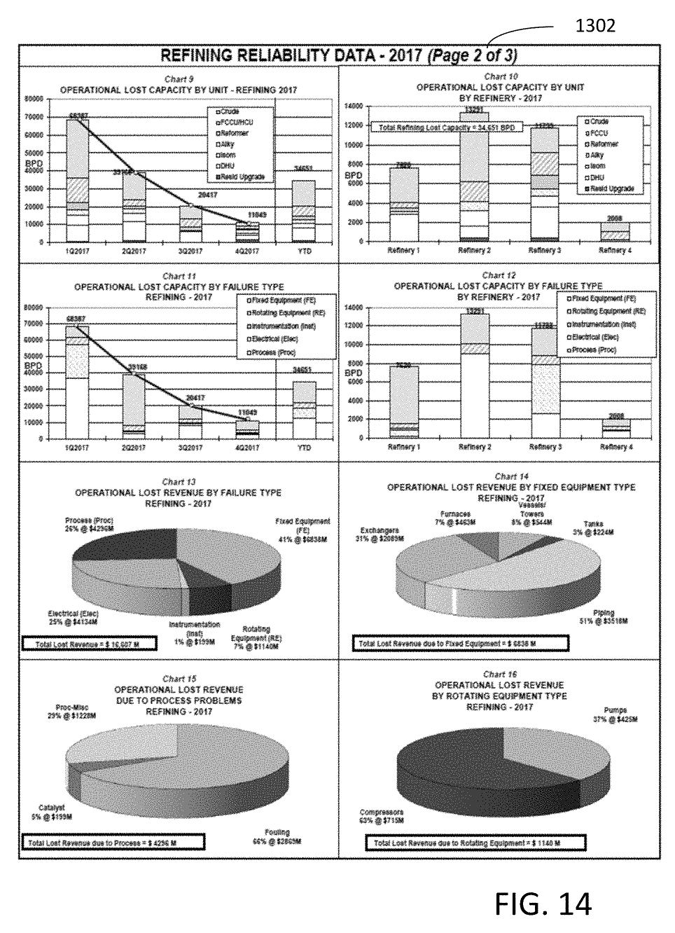

FIG. 14 illustrates a second portion of said plurality of reliability data charts 1302.

With organizational reporting hierarchy in mind, one goal of said management software 618 can be to analyze and trend cost minimization, drive asset optimization and conformance to process safety RAGAGEP (recognized and generally accepted good engineering practice) not for just any one facility, but across all facilities as well as enterprise-wide, and ultimately throughout industry (via API 754 adaptation).

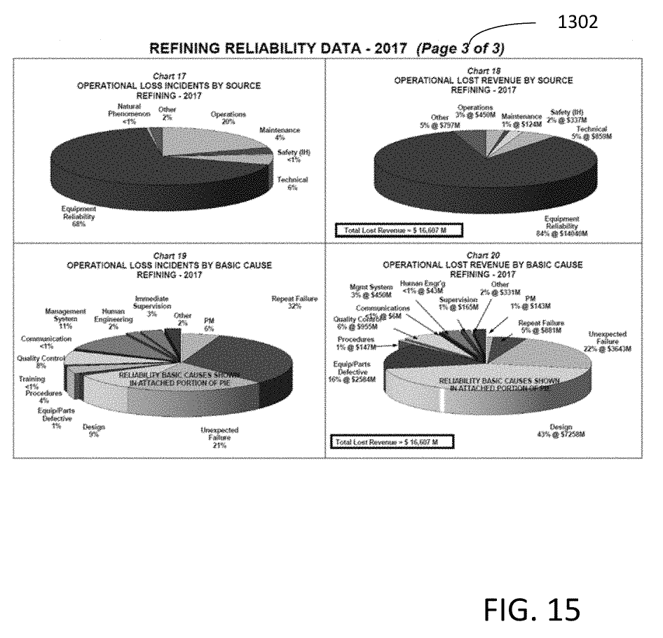

FIG. 15 illustrates a third portion of said plurality of reliability data charts 1302.

Afterall, “following the leader” in a range of best-in-class to next-to-last is what RAGAGEP conformance is all about, and in this highly regulated industry, there is strength as well as comfort in large numbers.

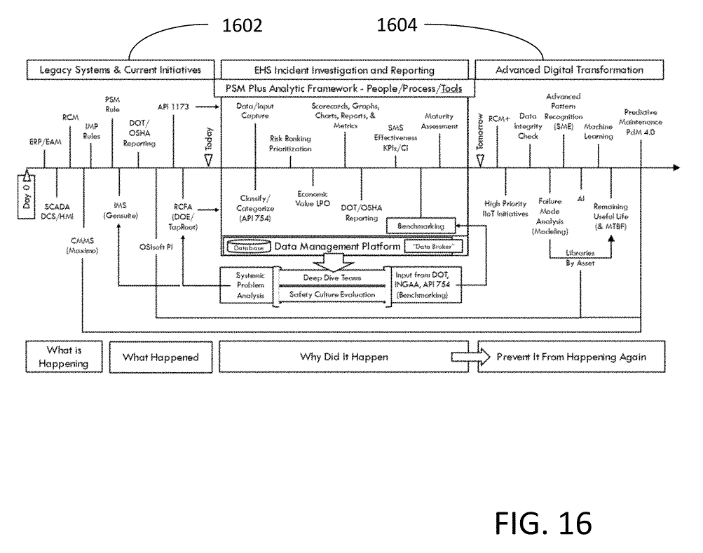

FIG. 16 illustrates where said management software 618 could fit in between legacy systems 1602 and advanced corrective action 1604.

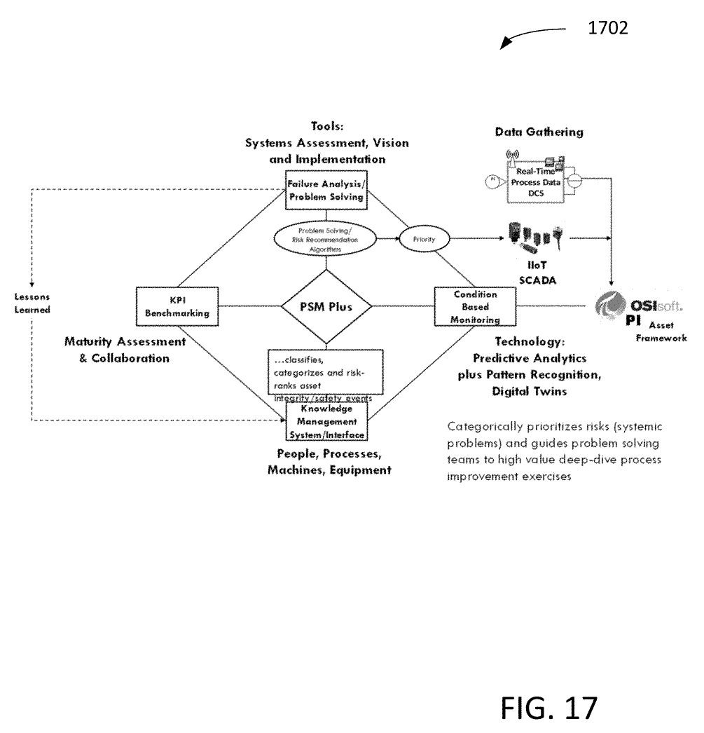

FIG. 17 illustrates an asset integrity analytical framework flowchart 1702.

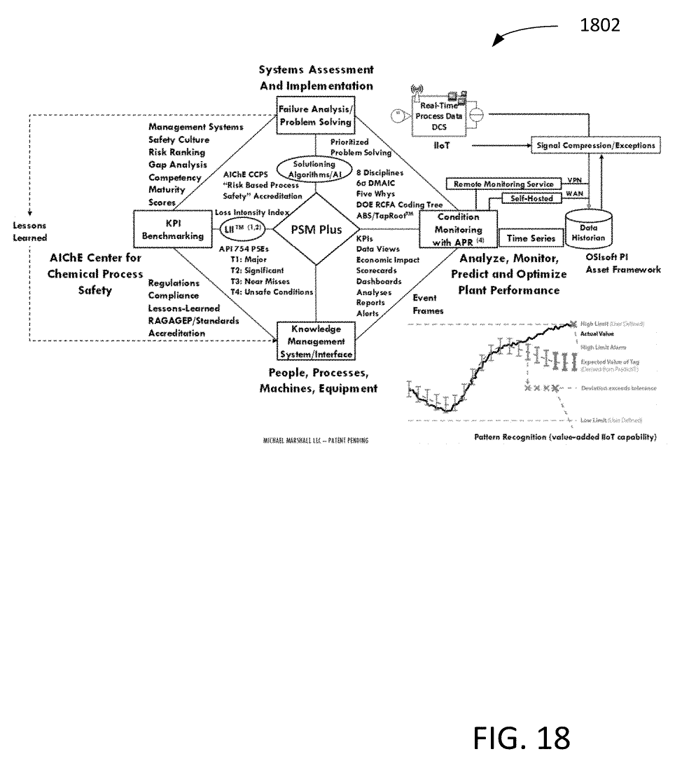

FIG. 18 illustrates a predictive process safety analytics 1802.

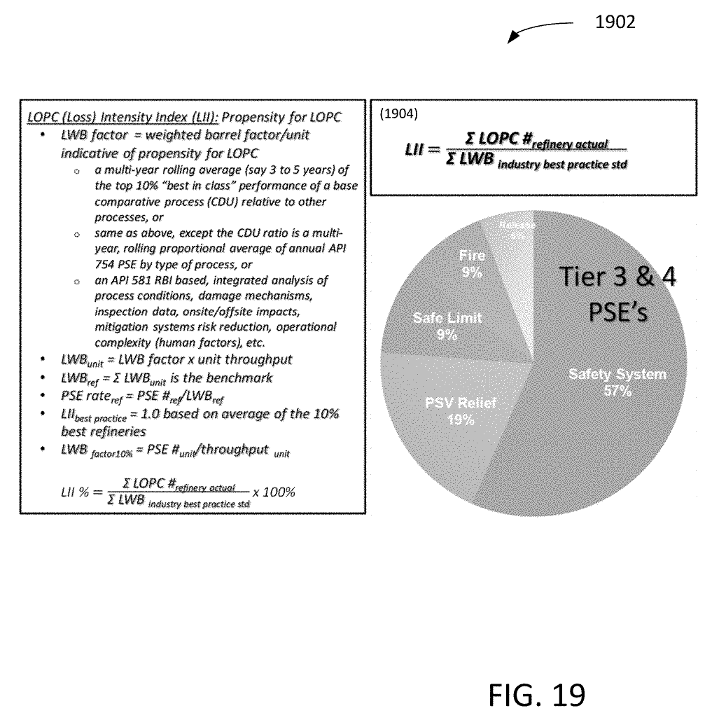

FIG. 19 illustrates an industry comparative benchmarking 1902.

In one embodiment, said management software 618 can comprise an intensity index 1904 (or LOPC (or Loss) Intensity Index) which can comprise a benchmarking methodology. In one embodiment, said intensity index 1904 can normalize LOPC data across all plant sizes, types and complexities, thus enabling operators to compare their propensity for incurring a LOPC event relative to their peer group/competition as well as conformance to RAGAGEP, and thereby identify specific areas for process safety performance improvement. This LII benchmarking approach serves as an ideal complement to API RP 754 “Process Safety Performance Indicators for the Refining and Petrochemical Industries,” as well as other industry comparative approaches.

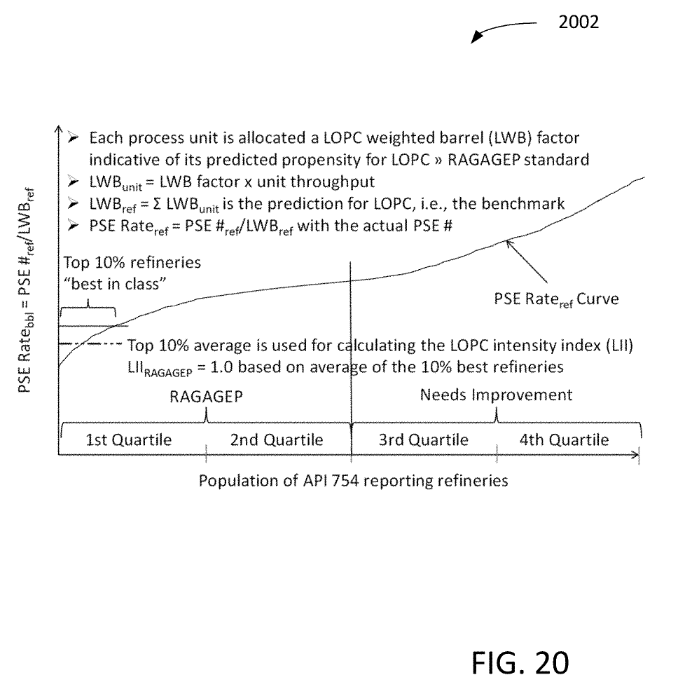

FIG. 20 illustrates a chart 2002.

In one embodiment, for said chart 2002 can comprise each process unit being allocated a LOPC weighted barrel (LWB) factor indicative of its predicted propensity for LOPC relative to a RAGAGEP standard. Top 10% average is used for calculating the LOPC intensity index (LII).

How does the PSE Rate and LWBref methodology work? And, what is a LOPC weighted barrel?

Each process unit is allocated a LOPC weighted barrel (LWB) factor indicative of its overall propensity for LOPC relative to a RAGAGEP standard. The LWB factor could be based on either (1) a multi-year rolling average of top 10% “best in class” PSE performance by process unit (PSE #/unit throughput), or (2) a risk modifier based on an integrated analysis of gas volume, liquid volume, material (flammability and toxicity), pressure, damage mechanisms, risk-based inspection data, onsite/offsite impacts, and mitigation systems risk reduction, e.g., tankfarm=5.0, CDU=4.7, FCCU=4.3, etc.

Throughput of each unit is multiplied by its LWB factor

LWBunit=LWB factor×unit throughput

Results from each unit are added up for a refinery total

LWBref=ΣLWBunit

LWBref represents the predicted result, or the RAGAGEP benchmark

The LWB factor could be based on either a multi-year rolling average of top 10% “best in class” PSE performance by process unit (PSE #/unit throughput), or a risk modifier based on an integrated analysis of gas volume, liquid volume, material (flammability and toxicity), pressure, damage mechanisms, risk-based inspection data, onsite/offsite impacts, and mitigation systems risk reduction, e.g., tankfarm=5.0, CDU=4.7, FCCU=4.3, etc.

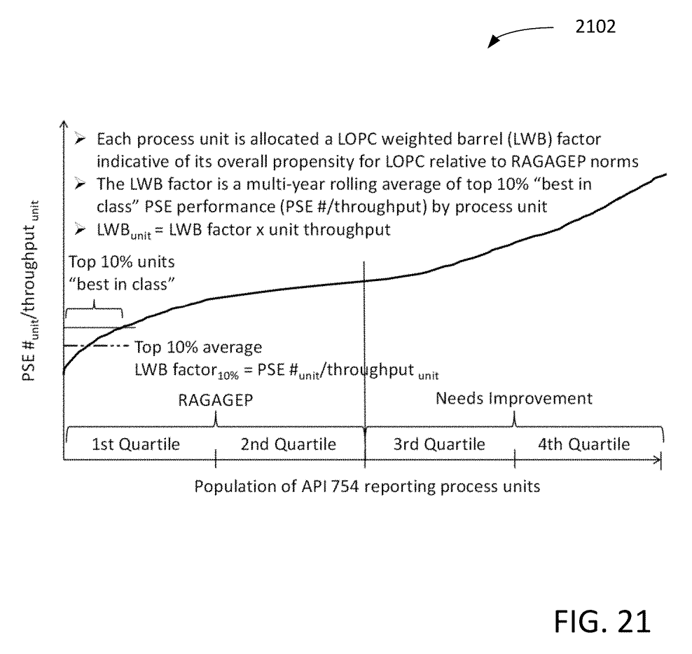

FIG. 21 illustrates a chart 2102.

Each process unit is allocated a LOPC weighted barrel (LWB) factor indicative of its overall propensity for LOPC relative to RAGAGEP norms. The LWB factor is a multi-year rolling average of top 10% “best in class” PSE performance (PSE #/throughput) by process unit.

The LWB factor and resulting LWBunit would be based on a multi-year rolling average of LOPC data (API 754 PSE Tier 1, 2, 3, 4 history).

Then, a PSE Rateref=PSE #ref/LWBref is calculated for each refinery and indicates a “per barrel” LOPC performance rate comparator.

LWBref is not a benchmark in itself, but is instead a common denominator which enables a benchmarking methodology to be developed.

The LWBref methodology provides a “per barrel” basis for purposes of comparison and benchmarking industry wide.

API 754 PSE rate is by workforce hours, which is counterintuitive (vs. per barrel denominator) and highly variable, e.g., skewed by manhours for major projects and turnarounds.

The LWB factor and resulting LWBunit would be based on a multi-year rolling average of LOPC data (API 754 PSE Tier 1, 2, 3, 4 history). LWB is not a benchmark in itself, but is instead a common denominator which enables a benchmarking methodology to be developed. The LWB methodology provides a “per barrel” basis for purposes of comparison and benchmarking industry-wide. The current API 754 PSE rate is by workforce hours, which is counterintuitive (vs. per barrel denominator) and highly variable, e.g., skewed by manhours for major projects and turnarounds.

What is the LOPC (loss) intensity index (LII), and how does it relate to LWBref?

After results from each unit are added up for a refinery total (LWBref=E LWBunit), thereby indicating the “allowable” predicted, then, A LOPC intensity index LII is determined for each refinery.

LIIRAGAGEP (=1.0) is the average of the 10% “best in class” refineries, i.e., the benchmark for comparison across the industry.

Each refinery's LII is calculated as follows

LIIref=“1−(PSE #ref−PSE #10% line)”/“PSE #10% line” at a specific LWB

Industry target LII≤1.0, but a RAGAGEP allowable, or maximum threshold could be established at some point>1.0

Instead of PSE # (and LII) by unit and refinery, could be by company, release type, point of release, operating mode, consequence, DAFW injuries, fatalities, workforce, offsite impacts, PSE Tier #, damage mechanism, etc. Also, as well as LII, could be applied to emissions (EII).

After results from each unit are added up for a refinery total, thereby indicating the “allowable” predicted, then a LOPC intensity index LII is determined for each refinery

LII (RAGAGEP=1.0) is the average of the 10% “best in class” refineries, i.e., the benchmark for comparison across the industry.

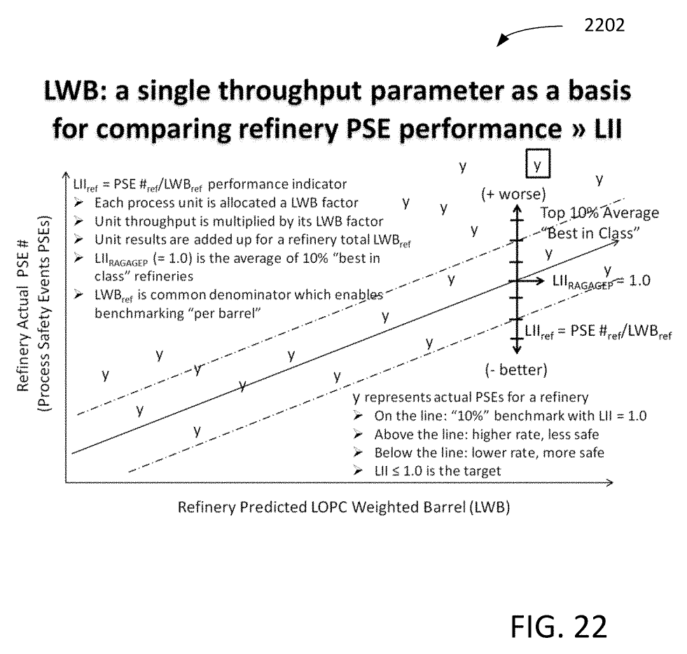

FIG. 22 illustrates a chart 2202.

LWB can comprise a single throughput parameter as a basis for comparing refinery PSE performance with LII≤1.0 as the target.

The following sentences are based partially on the claims and are included here as an example of preferred embodiments of the current system.

Said management system 100 for calculating said management solution 620 from said EAM data 616. Said management system 100 comprises said one or more computers 106 including at least said server 108, and said first computer 106a, and said network 112. Said server 108 comprises said EAM platform 614 comprising said server application 506. Said EAM platform 614 can be configured to collect said EAM data 616 selected among said financial data 612, said maintenance data 610, said engineering data 608, said operational data 606, and said incident data 604. Said one or more computers 106 further comprise said management software 618 configured to communicate with said EAM platform 614 and analyze said EAM data 616 to generate said management solution 620.

Said management software 618 comprises said machine learning module 718, said incident investigation and reporting module 716, said productivity improvement 714, said cost reduction 712, said risk management 710, said evaluating tools method 706, said evaluating processes method 704, and said evaluating people method 702.

Said method of use 602 of said management system 100 for calculating said management solution 620 from said EAM data 616. collecting said EAM data 616 with said EAM platform 614 on said server 108. analyzing said EAM data 616 with said management software 618 configured to communicate with said EAM platform (614). generating said management solution (620).

receiving said incident data 604, said operational data 606, said engineering data 608, said maintenance data 610 and said financial data 612 into said EAM platform 614.

receiving said equipment status data 804 from an operational equipment, analyzing said equipment status data 804 to determine said safety status 806, said maintenance status 808, said predictive health 810, and said predictive failure 812. evaluating failure analysis, API 754 guidelines analysis, risk ranking and LPO related to said operational equipment.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. A management system for calculating a management solution from an EAM data, wherein:
said management system comprises one or more computers including at least a server, and a first computer, and a network;
said server comprises an EAM platform comprising a server application;
said EAM platform is configured to collect said EAM data selected among a financial data, a maintenance data, an engineering data, an operational data, and an incident data; and
said one or more computers further comprise a management software configured to communicate with said EAM platform and analyze said EAM data to generate said management solution.

2. The management system of claim 1, wherein:
said management software comprises a machine learning module, an incident investigation and reporting module, productivity improvement, cost reduction, risk management, an evaluating tools method, an evaluating processes method, and an evaluating people method.

3. A method of use of a management system for calculating a management solution from an EAM data, wherein:
collecting said EAM data with an EAM platform on a server;
analyzing said EAM data with a management software configured to communicate with said EAM platform (614); and
generating said management solution (620).

4. The method of use of claim 3, wherein:
receiving an incident data, an operational data, an engineering data, a maintenance data and a financial data into said EAM platform.

5. The method of use of claim 3, wherein:
receiving an equipment status data from an operational equipment,
analyzing said equipment status data to determine a safety status, a maintenance status, a predictive health, and a predictive failure; and
evaluating failure analysis, API 754 guidelines analysis, risk ranking and LPO related to said operational equipment.
